(19) United States
(12) Patent Application Publication
(10) Pub. No.: US 2024/0190704 A1
(43) Pub. Date: Jun. 13, 2024

(54) Multi Tubular Metal Hydride Reactor With an Integrated Buffer Storage

(71) Applicant: INDIAN INSTITUTE OF TECHNOLOGY BOMBAY, Maharashtra (IN)

(72) Inventors: Pratibha Sharma, Maharashtra (IN); Nandlal Gupta, Maharashtra (IN); Saurabh Tiwari, Maharashtra (IN); _ NITIN, Maharashtra (IN); Afzal Mahvash, Maharashtra (IN)

(73) Assignee: INDIAN INSTITUTE OF TECHNOLOGY BOMBAY, Maharashtra (IN)

(21) Appl. No.: 18/536,593

(22) Filed: Dec. 12, 2023

(30) Foreign Application Priority Data
Dec. 12, 2022 (IN) 202221071571

(51) Int. Cl. C01B 3/00; B01J 8/06

(52) U.S. Cl. CPC C01B 3/0068; B01J 8/065; B01J 8/067; B01J 2208/00194; B01J 2208/00884

(57) ABSTRACT

The present invention relates to a multi tubular metal hydride reactor with integrated buffer storage. The present invention more particularly relates to metal hydride reactor with integrated buffer storage configuration with 7 tubes with metal hydride and 4 longitudinal fines attached to 5 concentric rings, the metal hydride tubes are supported by means of 4 baffles, having a total 50 kg LaNis distributed equally among the tubes and water as heat transfer fluid flows across the shell for heat transfer. The metal hydride reversibly stores 680 grams of hydrogen amounting to 1.34 wt. % of gravimetric capacity of metal hydride and equivalent energy storage of 10.4 MJ. In case of absorption, when the flow rate selected was 20 LPM the absorption time for 90% reaction completion was observed to be 1286 s (21.4 min) at 30 bar H₂ supply pressure. In case of desorption studies, it was observed that the varying flow rate from 15 to 25 LPM has negligible effect on hydrogen desorption hence 15 LPM was selected as a flow rate for further desorption experiments. Further increasing HTF temperature from 60° ° C. to 80° C. improves the performance significantly.

### FIELD OF THE INVENTION

The present invention relates to a multi tubular metal hydride reactor with integrated buffer storage. The present invention more particularly relates to metal hydride reactor with integrated buffer storage configuration with 7 tubes supported by means of 4 baffles having total 50 kg LaNis distributed equally among them and water as heat transfer fluid flows across the shell for heat transfer. Each of the seven tubes has coaxially placed copper longitudinal fins, mounted on cylindrical copper concentric rings. Fins are provided for effective heat transfer from the core of the metal hydride bed and rings to support fins as well as allow uniform material filling from the filling port.

### BACKGROUND OF THE INVENTION

Energy is the major input for the economic development of any country. Due to fast depletion of fossil fuels, there is a need for an alternate energy source to meet the growing energy demand of the world. Hydrogen as an energy carrier is the way forward to satisfy this growing demand of energy due to its high energy density and clean exhaust to combustion. The major challenge for using hydrogen as an energy carrier is its storage. Storing hydrogen in gaseous and liquid phase is a cost and energy intensive process. This put forward the way of storing hydrogen in solid state form.

Among the various known solid-state hydrogen storage material, complex hydrides (i.e., NaBH₄, LiAlH₄, and etc.) are the class of materials which offers high gravimetric capacity as compared to favourable metal hydrides (i.e. LaNis, TiFe, Mg₂Ni, and etc.). In order to use complex hydrides for large scale applications there are several major challenges associated in terms of its low effective gravimetric hydrogen storage capacity, irreversibility of hydrolysis and high regeneration costs.

There have been continued efforts in the literature to resolve the challenges associated with regeneration of complex hydrides in energy and cost-efficient manner aimed at one step hydrogen generation. However, there will be frequent loading and unloading of complex hydride in each cycle due to off board regeneration being required which can be resolved using metal hydrides.

Metal hydrides offer a promising solution to store hydrogen in solid state for long term with good volumetric efficiency. The main driving force for the absorption or desorption of hydrogen from metal hydrides is the difference between the equilibrium pressure and the supply/outlet pressure. The dependency of equilibrium pressure on temperature necessitates the removal of heat during absorption as this charging process is exothermic in nature. The desorption of hydrogen from metal hydrides or the discharging process is an endothermic process. This put forward the need of efficient heat transfer management inside a metal hydride reactor.

CN108745261 teaches development of multi-unit metal hydride reactor for thermal storage.

CN105289440 teaches metal hydride-based hydrogen storage reactor with fin and spiral coil type heat exchanger.

Several numerical and experimental studies are conducted on the design of metal hydride reactors to improve the heat transfer process inside it.

M. Afzal, R. Mane, and P. Sharma, “Heat transfer techniques in metal hydride hydrogen storage: A review,” Int. J. Hydrog. Energy, vol. 42, no. 52, pp. 30661-30682, December 2017, doi: 10.1016/j.ijhydene.2017.10.166. This article teaches the heat transfer techniques in metal hydride hydrogen storage.

Among the metal hydride properties, efforts have been made to improve the effective thermal conductivity of metal hydride by inclusion of metal foams and expanded natural graphite compacts. Besides thermal conductivity, several efforts have been made to increase the heat transfer area inside metal hydride reactor by integrating internal and external fins (longitudinal, transverse), by using cooling tubes (straight, helical, U shape etc.) embedded inside metal hydride reactor and by using jacket around the metal hydride reactor. It was found out that the heat transfer is fast when these are incorporated inside a metal hydride reactor.

Another important parameter affecting the performance of metal hydride reactors is the heat transfer coefficient. The use of various heat transfer fluids (water, air, oil, etc.) and by increasing the velocity of heat transfer fluid (HTF) results in the increment of heat transfer coefficient which further results in the faster heat transfer and finally improves the rate of the absorption and desorption process. The heat transfer improvement was also observed by decreasing/increasing the HTF temperature during absorption/desorption process.

Among the performance parameters, the supply pressure/outlet pressure during absorption/desorption is also an important parameter to consider. The increment in supply pressure during absorption increases the difference between the equilibrium pressure and the supply pressure which results in faster absorption of hydrogen inside a metal hydride reactor. Another way to improve the heat transfer performance of metal hydride reactors is by decreasing the radius of bed.

M. Afzal, N. Sharma, N. Gupta, and P. Sharma, “Transient simulation studies on a metal hydride based hydrogen storage reactor with longitudinal fins,” J. Energy Storage, vol. 51, no. November 2021, p. 104426, 2022, doi: 10.1016/j.est.2022.104426. The study in the research paper is based on numerical simulations carried on computer.

It is seen from literature that a lot of efforts have been made to improve the heat transfer process inside the metal hydride reactor. However, the majority of these studies focus on small scale systems and the results of large metal hydride reactors are very less, specifically in terms of experimental demonstrations.

The present inventors have addressed the problem of the prior art by designing a large-scale metal hydride reactor having a capacity to hold 50 kg of metal hydride (LaNis) with 20% of expansion volume. For the experimentation purpose, 50 kg of MH powder was used and applicable for stationary back up power generation.

The effect of bed radius is primarily analyzed in terms of improving heat transfer from the core of the metal hydride bed to the surrounding. To reduce the radius of bed in the present invention, the metal hydride reactor is divided into seven smaller tubes which are housed in a cylindrical vessel through which the HTF (water) is flowing i.e., a multi-tubular reactor housed in a cylindrical shell/vessel with an integrated hemispherical buffer storage and water as a HTF is used as a heat transfer medium in the present invention. Further, the performance of this metal hydride reactor is experimentally investigated in the present invention based on the absorption and desorption cycle at various operating conditions.

In the present invention, the developed system can be utilized to store hydrogen produced from different methods such as electrolysis and deliver the energy on demand to the end use on integration with low temperature PEM fuel cell stack. The metal hydride reactor of the present invention with integrated buffer storage can be used for different applications such as compact hydrogen storage, hydrogen compression, backup power generation and low temperature thermal energy storage (water heater).

### OBJECTS OF THE INVENTION

The principal object of the present invention is to provide a multi-tubular reactor having integrated buffer storage with a housing of HTF.

It is another object of the present invention to provide a multi tubular metal hydride reactor with integrated buffer storage configuration with 7 MH tubes supported by means of 4 baffles having total 50 kg LaNis distributed equally among them and water as heat transfer fluid flows across the shell for heat transfer.

It is another object of the present invention wherein in order to improve the heat transfer from the core of the metal hydride bed, 4 copper longitudinal plate fins supported over 5 cylindrical copper rings placed coaxially in each metal hydride tube.

### SUMMARY OF THE INVENTION

In an aspect of the present invention there is provided a multi tubular metal hydride reactor with integrated buffer storage arrangement comprising:
i. Shell housing for heat transfer fluid (HTF) wherein water acts as a cooling/heating HTF;
ii. 7 metal hydride (MH) tubes filled with LaNis metal hydride powder within the shell wherein each MH tube has embedded heat transfer unit (fin assembly) in MH powder for heat transferring from and to the central core;
iii. 4 longitudinal fins inserted in each MH tubes which are fixed to 5 central rings to enhance the heat transfer and for uniform metal hydride filling throughout the tubes; The thickness of each fin plate; diameter, thickness and length of central rings is optimized and based on the mechanical strength consideration, uniform distribution of MH powder and heat transfer area required. For any higher capacity, the number of fins, its thickness, diameter and length and number of central rings would vary as per capacity;
iv. 4 baffle plates for supporting the MH tubes which also provide additional heat transfer surface area and create turbulence for heat transfer;
v. Hydrogen gas (H₂) inlet into the integrated buffer and acting on the circular area providing sufficient area for hydrogen inlet while minimizing the pressure loss;
vi. Two end plates to separate the HTF and gas circuits;
vii. MH tubes protrude the top and bottom plate;
viii. Disc filter to separate the gas and MH powder during the desorption operation as well as to supply hydrogen to the MH tubes;
ix. Two hemispherical covers to close the top and bottom portions of the reactor;
x. The volume enclosed within top hemispherical cover and top end plate act as integrated buffer hydrogen storage;
xi. Inlet and outlet for HTF across the shell to allow the flow of the HTF inside the shell area of the reactor.

### BRIEF DESCRIPTION OF FIGURES

FIG. 1.a. illustrates the CAD Layout of MH based Hydrogen Storage Reactor.

FIG. 1.b. illustrates the Schematic of Shell and 7 MH Tubes Reactor configurations.

FIG. 1.c. illustrates Heat transfer enhancement consisting of four longitudinal fins connected to an array of cylinders.

FIG. 2 illustrates the schematics of the experimental setup used for experimentation of a 50 kg alloy storage reactor.

FIG. 3 is the graph illustrating the effect of HTF flow rate on hydrogen absorption reaction kinetics and average MH bed temperature.

FIG. 4.a. is the graph illustrating the temperature difference of water between shell inlet and outlet for different HTF flow rate during absorption studies.

FIG. 4.b. is the graph illustrating the temperature difference of water between shell inlet and outlet for different hydrogen supply pressure during absorption studies.

FIG. 5 is the graph illustrating the energy analysis for absorption process with different HTF flow rate for a period of 3600 s.

FIG. 6.a. is the graph illustrating the effect of Supply Pressure on hydrogen absorption reaction kinetics and average MH bed temperature.

FIG. 6.b. is the graph illustrating the variation of equilibrium pressure of MH bed with respect to the variation in MH bed temperature computed using van′t Hoff equation.

FIG. 7 is the graph illustrating the energy analysis for the absorption process performed at different hydrogen supply pressures of 20 bar, 25 bar and 30 bar at a constant flow rate of 20 LPM for a duration of 3600 seconds.

FIG. 8.a. is the graph illustrating the effect of HTF flow rate on hydrogen desorption reaction kinetics

FIG. 8.b. is the graph illustrating the variation in the temperature difference of the heat transfer fluid between inlet and outlet of reactor shell during desorption studies performed at different HTF flow rates.

FIG. 9 is the graph illustrating the energy analysis for the desorption process performed at different HTF flow rates.

FIG. 10.a. is the graph illustrating the effect of HTF temperature on hydrogen desorption reaction kinetics for duration of 7200 s.

FIG. 10.b. is the graph illustrating the temperature difference curve of water inlet and outlet for desorption studies with different temperature of HTF.

FIG. 11 is the graph illustrating the effect of HTF temperature on desorption equilibrium pressure.

FIG. 12 is the graph illustrating the energy analysis computed for the desorption process performed at atmospheric pressure with a constant HTF flow rate of 15 LPM and at different HTF temperatures of 60° C., 70° C. and 80° ° C.

### DETAILED DESCRIPTION OF THE INVENTION

The present invention relates to a multi tubular metal hydride reactor with integrated buffer storage. The present invention more particularly relates to metal hydride reactor with integrated buffer storage configuration with 7 tubes supported by means of 4 baffles having total 50 kg LaNis distributed equally among them and water as heat transfer fluid flows across the shell for heat transfer.

In an embodiment of the present invention there is provided a multi tubular metal hydride reactor with integrated buffer storage arrangement comprising:
i. Shell housing for heat transfer fluid (HTF) wherein water acts as a cooling/heating HTF;
ii. 7 metal hydride (MH) tubes filled with LaNis metal hydride powder housed within the shell wherein each MH tube has embedded heat transfer unit (fin assembly) in MH powder for heat transferring from and to the central core;
iii. 4 longitudinal fins inserted in each MH tubes which are fixed to 5 central rings to enhance the heat transfer as well as allow the powder filling in the MH tubes; This is the unique design of Heat transfer enhancement where in one unit consisting of five central rings with four 3 mm longitudinal fins each is placed at 90 degrees to one another. The thickness of longitudinal fins, inner and outer diameter of rings, spacing between the rings and number of longitudinal fins in one unit is determined based on capacity of MH powder, size of each tube, mechanical strength considerations;
iv. 4 baffle plates for supporting the MH tube which also provide additional heat transfer surface area and create turbulence for heat transfer;
v. Hydrogen gas (H₂) inlet into the integrated buffer and acting on the circular area providing sufficient area for hydrogen inlet while minimizing the pressure loss;
vi. Two end plates to separate the HTF and gas circuits;
vii. MH tubes protrude the top and bottom plate;
viii. Disc filter to separate the gas and MH powder during the desorption operation as well as to supply hydrogen to the MH tubes;
ix. Two hemispherical covers to close the top and bottom portions of the reactor;
x. The volume enclosed within top hemispherical cover and top end plate act as integrated buffer hydrogen storage;
xi. Inlet and outlet for HTF across the shell to allow the flow of the HTF inside the shell area of the reactor.

In an embodiment of the present invention during absorption of hydrogen, HTF flow rate is in the range from 15 LPM to 25 LPM and hydrogen supply pressure is in the range from 20 bar to 30 bar.

In another embodiment of the present invention during desorption of hydrogen, HTF flow rate is in the range from 15 LPM to 25 LPM and HTF temperature is in the range from 60° ° C. to 80° C.

In a preferred embodiment of the present invention there is provided a multi tubular metal hydride reactor with integrated buffer storage arrangement is filled with a 50 kg LaNis metal hydride powder in 7 MH tubes.

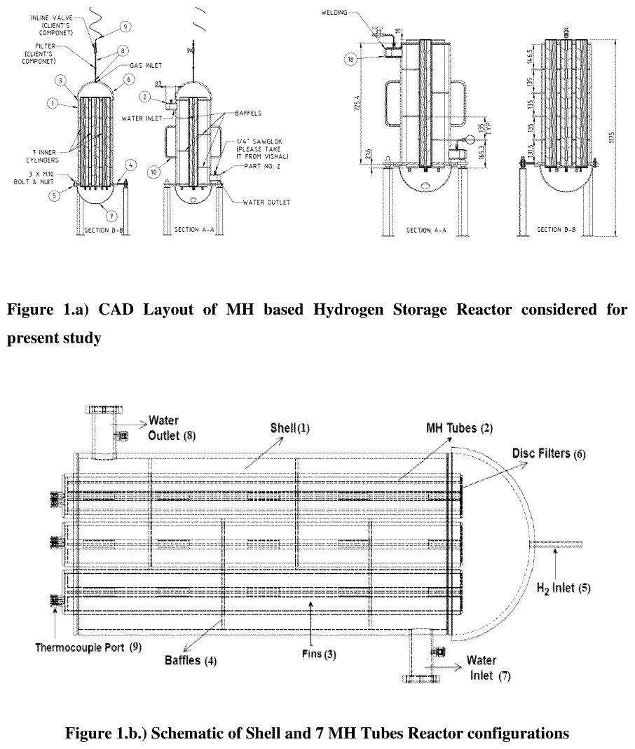

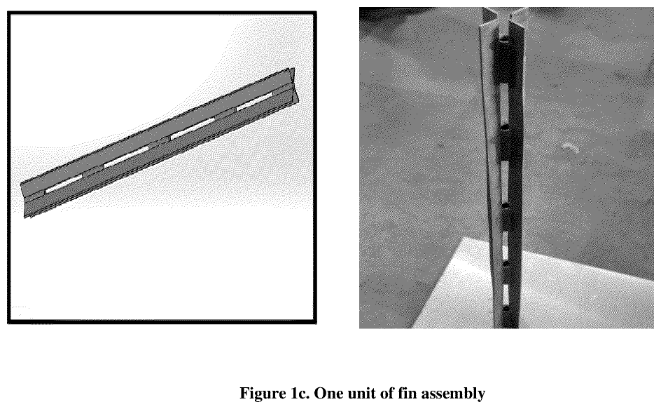

The MH tube arrangement is shown in FIG. 1.b where each tube (2) has an inner diameter of 63.7 mm and an outer diameter of 73.03 mm with a length of 756 mm. The dimensions of each tube incorporate 20 percent expansion volume for hydride formation. 4 longitudinal fins (3) of 3 mm thickness and 750 mm height are inserted in each MH tubes (2) which are fixed to 5 central rings to enhance the heat transfer. Five such central rings with a height, the inner and outer diameters of 60 mm, 12.7 mm, and 19 mm respectively are used to fix the fins within one MH tube. The outer shell (1) with inner and outer diameters of 280 mm and 299 mm utilizes the HTF flow arrangement where water acts as a cooling/heating HTF. Two end plates with 12 mm thickness are inserted to separate the water and gas circuits. Inlet (7) and outlet (8) for water flow across the shell having an inner and outer diameter of 42.5 mm and 59.6 mm respectively allow the flow of the water inside the shell area of the reactor. Two hemispherical covers are used to close the top and bottom portions of the reactor having an inner diameter of 299 mm and thickness of 12 mm. The MH tubes protrude the top and bottom plate by 15 mm each. A disc filter (6) of 0.2 microns is used to separate the gas and MH powder during the operation. In addition to fins, to improve the heat transfer coefficient, by creating turbulence in water flow and to support the metal hydride tubes, 4 baffle plates (4) of 5.5 mm thickness are inserted as shown in FIG. 1.b. (4 baffles plates are used to support the metal hydride tubes inside the shell which also acts as an additional heat transfer surface area and imparts turbulence to HTF flow resulting in high heat transfer coefficient for heat transfer).

The distance of 135 mm between the baffle plates is maintained constant whereas the end baffles are away from the top and bottom plates by a distance of 165.3 mm. Seven K-type thermocouples (9) are placed at the bottom part of the MH tubes penetrating 70 mm inside along the axis of the tubes with two thermocouples at PCDs of 16 mm and 32 mm, one at 46 mm and two at the center of the tube. The temperature measured by them is logged with the help of the Keysight 970A DAQ data logger. In addition to these, two more K-type thermocouples are placed at the water inlet and outlet of a reactor and data was recorded using a Masibus 85XX+datalogger.

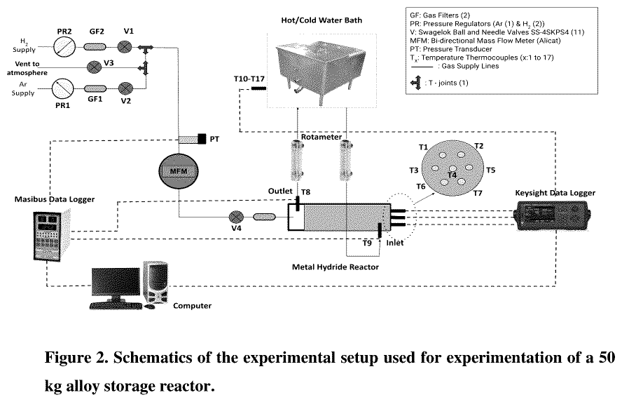

A multipurpose heating/cooling water storage tank of 500 liters' capacity has been used. A total number of 6 heating coils each of 1.5 kW capacity are fixed in the bottom-most part of the tank with a total capacity of 9 kW and can be controlled by 3 switches to adjust the temperature of the stored water in the tank. This stored water is supplied to the metal hydride-based hydrogen storage reactor via an inlet and recirculated to the storage tank via the outlet of the reactor. A centrifugal pump of Crompton 0.5 HP capacity is used for the pumping of water from the tank and the water flow rate is fixed using control valves monitored by a rotameter. The inlet and outlet rotameters having a range of 0-40 LPM are fixed vertically on the wall to measure the respective flow rates of water. 8 K-type thermocouples with an accuracy of +/−2.2° C. are fixed horizontally on the vertical side plane surface of the water storage tank to measure the temperature variation across the height of the tank. Alternate thermocouples are inserted inside the tank by 120 mm and 250 mm. The temperature of the water is logged with the help of a Keysight DAQ 970A data logger and a computer used to record readings. On the other hand, the gas circuit consists of gas pipelines connected to the inlet of the reactor via Sievert's apparatus which simplifies the gas supply pipeline to the reactor separating the paths during absorption and desorption. An absolute Baumer pressure transducer with a range of 0-100 bar and a standard measurement error of 0.2% FSR is used to measure the pressure of hydrogen gas inside the reactor and logged with the help of Masibus 85XX+data logger having an accuracy of 0.1% of full scale. The flow rate of gas is measured with the help of an Alicat CODA-Series bi-directional mass flow meter having a range of 0-12 kg/hr and the least count of 0.0055 g/s. The hydrogen flow is controlled by a ball valve at the gas inlet (5) of the reactor. The complete experimental set up is shown in FIG. 2.

### Experimental Procedure:

The 50 kg novel multi tubular metal hydride reactor with integrated buffer storage consisting of 7 MH tubes was initially tested for leak by supplying argon gas at 60 bar using Sieverts apparatus and kept under observation for a week. The reactor was filled with the total 50 kg LaNis alloy in 7 MH tubes wherein each tube accommodated 7.143 kg of LaNis alloy through a thermocouple port of 6.35 mm diameter and on completion of alloy filling in each tube, the thermocouples were inserted via filling ports in each bed upto a depth of 70 mm and sealed using nut ferrule end connection. The AB5 type intermetallic compound LaNis alloy was selected for this study as it is one of the most studied alloys for solid state hydrogen storage in literature with maximum reported capacity of 1.5 wt. %, ease of activation, low pressure and ambient temperature operation giving reversible hydrogen storage capacity of 1.28 wt. % at 298 K for several hundreds of cycles and the desorption equilibrium pressure of 1.8 bar at 298 K. The MH Reactor was further subjected to gradual pressure testing using argon and hydrogen gas from 5 bar to 50 bar in the steps of 5 bar in order to ensure that reactor joints are entirely leak proof.

### Activation of Alloy:

The activation cycle of metal hydride bed was initiated by evacuating the MH bed to 10-3 mbar followed by simultaneous heating and maintaining bed temperature at 60° C. by circulating water as a heat transfer fluid across shell of MH reactor at flow rate of 15 LPM for duration of 6 hours, afterwards the HTF circulation was stopped and the metal hydride bed was subjected to a constant 30 bar hydrogen pressure supply via Sieverts apparatus and allowed to cool down to room temperature)(27° ° C. in a natural convection mode. In order to activate the alloy completely, three such activation cycles were performed wherein it was observed that the metal hydride stored 680 grams of hydrogen accomplishing the maximum capacity of 1.34 wt. %. Further to analyze the sorption kinetics of the system at room temperature, two more cycles of absorption experiment were conducted with supply pressure of 30 bar, HTF flow rate at 15 LPM and HTF temperature of 30° C., wherein it was observed that the bed absorbs 1.34 wt. % of hydrogen in the 3000 s in both cycles. So it was concluded that the alloy is fully activated to its maximum gravimetric capacity for further experiment.

The MH reactor was studied for its absorption and desorption characteristics experimentally by varying different operating conditions of absorption and desorption respectively. The lists of conditions for the experimental studies are listed in Table 1.

TABLE 1
Experimental operating conditions for
hydrogen absorption and desorption

| | Absorption | | |
|---|---|---|---|
| Experiment | Effect of Heat Transfer Fluid (HTF) flow rate | | |
| Case 1: | H₂ Pressure | HTF Flow rate | Bed Temperature |
| Parameters | (in bar) | (in LPM/(m³/s)) | (in ° C.) |
| Level A | 30 | 15/(2.5 × 10⁻⁴) | 30 |
| Level B | 30 | 20/(3.33 × 10⁻⁴) | 30 |
| Level C | 30 | 25/(4.17 × 10⁻⁴) | 30 |
| | Effect of H₂ Supply Pressure | | |
| Case 2 | H₂ Pressure | HTF Flow rate | Bed Temperature |
| Parameters | (in bar) | (in LPM/(m³/s)) | (in ° C.) |
| Level A | 20 | 20/(3.33 × 10⁻⁴) | 30 |
| Level B | 25 | 20/(3.33 × 10⁻⁴) | 30 |
| Level C | 30 | 20/(3.33 × 10⁻⁴) | 30 |
| | Desorption | | |
| Experiment | Effect of Heat Transfer Fluid (HTF) flow rate | | |
| Case 1 | Outlet Pressure | HTF Flow rate | Bed Temperature |
| Parameters | (in bar) | (in LPM/[m³/s]) | (in ° C.) |
| Level A | 1 | 15/(2.5 × 10⁻⁴) | 60 |
| Level B | 1 | 20/(3.33 × 10⁻⁴) | 60 |
| Level C | 1 | 25/(4.17 × 10⁻⁴) | 60 |
| | Effect of Initial Bed temperature | | |
| Case 2 | Outlet Pressure | HTF Flow rate | Bed Temperature |
| Parameters | (in bar) | (in LPM/[m³/s]) | (in ° C.) |
| Level A | 1 | 15/(2.5 × 10⁻⁴) | 60 |
| Level B | 1 | 15/(2.5 × 10⁻⁴) | 70 |
| Level C | 1 | 15/(2.5 × 10⁻⁴) | 80 |

### Absorption:

The absorption process using intermetallic compounds in solid state hydrogen storage is exothermic in nature owing to which it becomes crucial to dissipate the heat generated in MH bed for maximum hydrogen storage at higher absorption rate kinetics. In the present invention 4 longitudinal copper fins of 3 mm thickness fixed on 5 copper central rings are coaxially placed within each tube for improving heat transfer from core of the MH bed. Also, 4 baffles inside the shell is used to provide support to the MH tubes, these also acts as fin and increases heat transfer coefficient by means of turbulence and water at 30° C. as heat transfer fluid is circulated in shell portion of MH reactor to enhance the heat transfer from the MH bed. The experiments are performed by using normal tap water to analyze the real time scenario of reactor deployment for any application. In the first phase of the absorption experiment, the effect of water flow rate on the rate of hydrogen absorption was studied by varying it from 15 LPM to 25 LPM in the steps of 5 LPM at 30 bar hydrogen supply pressure and HTF temperature at 30° C. In the second phase of the absorption experiment, the effect of hydrogen supply pressure from 20 bar to 30 bar in steps of 5 bar on hydrogen absorption in MH bed at optimum HTF flow rate of 20 LPM and temperature 30° C. was studied.

### Desorption:

The hydrogen desorption from MH bed is an endothermic process wherein energy equivalent or greater than the enthalpy of reaction is supplied to the MH bed to release hydrogen for the end use application. In the present study, the desorption was performed at atmospheric pressure. Further, in terms of parametric analysis, initially the effect of HTF flow rate varying from 15 LPM to 25 LPM was examined maintaining the bed temperature at 60° C. by circulating the HTF from hot water bath and the effect of HTF temperature or bed temperature on desorption rate was studied by varying the temperature from 60° C. to 80° C. in the steps of 10° C. at 15 LPM.

### Energy Analysis:

In the present invention experimental study, the energy analysis was performed in order to analyze the energy transfer between MH and HTF for absorption and desorption processes.

In case of absorption which is an exothermic process, the energy is released by bed and water as a heat transfer fluid is utilized to remove the heat from MH bed for completion of reaction.

The energy released by MH bed during absorption was computed using the below equation:

Q_{released,MH}=M_{H2}×ΔH_{MH} (1)

where, m_{H2} is the amount of hydrogen stored and ΔH_{MH} is the reaction enthalpy which was taken as 30800 J/mol.

The energy recovered or removed by HTF was calculated using the below equation:

Q_{HTF}=M_{HTF}×C_{pHTE}×(T_{HTF,e}−T_{HTF,i})×Δt (2)

where, M_{HTF} is the mass flow rate of HTF, T_{HTF,e} denotes the exit temperature of HTF, T_{HTF,i} denotes the inlet temperature of HTF and Δt is the time interval in seconds. In case of absorption process, the heat will be recovered by HTF whereas during desorption process, the heat will be supplied by HTF to metal hydride bed.

The HTF (water) inlet and outlet temperature was measured using K-Type thermocouples at both inlet and outlet.

In case of desorption which is an endothermic process, the MH bed requires energy to release hydrogen which is supplied by the means of HTF at higher temperature in the range 60° C. to 80° C.

The energy required by MH bed during desorption was computed using the below equation:

Q_{required,MH}=M_{H2}×ΔH_{MH} (3)

where, m_{H2} is the amount of hydrogen stored and ΔH_{MH} is the reaction enthalpy which was considered to be 30800 J/mol.

Van′t Hoff equation: The equilibrium pressure of metal hydride bed during absorption and desorption with respect to change in metal hydride bed temperature at an instant can be computed using the following van′t Hoff equation:

$$\frac{{P}_{eq}}{{p}_{ref}} = exp ( \frac{Δ S}{R} - \frac{Δ H}{RT} ) \qquad ( 4 )$$

where, P_{ref}=1 atm, Entropy of formation, ΔS=108 J/mol-K, Enthalpy of formation, ΔH=30800 J/mol, R is the Universal gas constant=8.314 J/mol-K.

### Experimental Results:

### Effect of Heat Transfer Fluid (HTF) Flow Rate on H₂ Absorption:

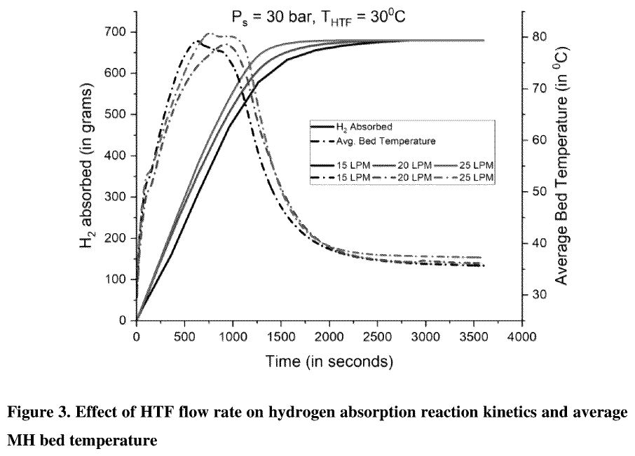

The influence of HTF (water) flow rate on the rate of hydrogen absorption in MH bed was investigated by varying the flow rate from 15 LPM to 25 LPM in the steps of 5 LPM at hydrogen supply pressure of 30 bar and HTF temperature maintained at 30° C. flowing through the inlet of the reactor shell. The heat transfer coefficients for different flow rates were measured using the Kern's Method. The heat transfer coefficients obtained are 495.97 W/m²-K, 580.96 W/m²-K, and 656.89 W/m²-K for HTF flow rate 15 LPM, 20 LPM and 25 LPM respectively. FIG. 3 shows the evolution of reaction kinetics and behavior of average bed temperature corresponding to different flow rates of HTF. It was observed that for HTF flow rate of 15 LPM the MH bed absorbs a maximum of 680.07 grams of hydrogen which corresponds to 1.34 wt. % in 2856 s, 90% of the reaction fraction completed in 1451 s and maximum bed temperature rises to 77.02° C. in 849 s. Further, when HTF flow rate was increased to 20 LPM the heat transfer coefficient at the outer surface of MH tube increases resulting in the increment of absorption rate, wherein 90% of the reaction fraction inside metal hydride reactor is completed in 1286 s which is 12.8% improvement compared to 15 LPM, and MH bed achieves maximum capacity of 680.07 grams hydrogen in 2675 s and maximum bed temperature rises to 78.64° C. in 925 s. In order to see the effect of HTF flow rate further, when the flow rate of HTF was increased to 25 LPM, the 90% reaction fraction completed in 1154 s which is an improvement of 11.3% and 25.7% in the time required for 90% reaction completion, as compared to 20 LPM and 15 LPM respectively. The bed achieves maximum capacity of 680.07 grams of hydrogen in 2281 s with peak average bed temperature of 7 MH tubes rises to 80.77° C. in 762 seconds which can be related to faster absorption rate. In terms of analyzing the effect of heat transfer coefficients, it was observed that increasing the heat transfer coefficient beyond 600 W/m²-K has no significant effect on enhancing heat transfer rate from the core of MH bed which have also been analyzed and reported by K. Jiao et al. [Jiao, K., Li, X., Yin, Y., Zhou, Y., Yu, S., & Du, Q. (2012); Effects of various operating conditions on the hydrogen absorption processes in a metal hydride tank. Applied Energy, 94, 257-269] and S. Tiwari et. al. [Tiwari, S., & Sharma, P. (2022); Parametric and Sensitivity Analysis of Metal Hydride Hydrogen Storage Systems for Development of Novel Design Charts. In Energy Storage, 2022; 4(5): 343.].

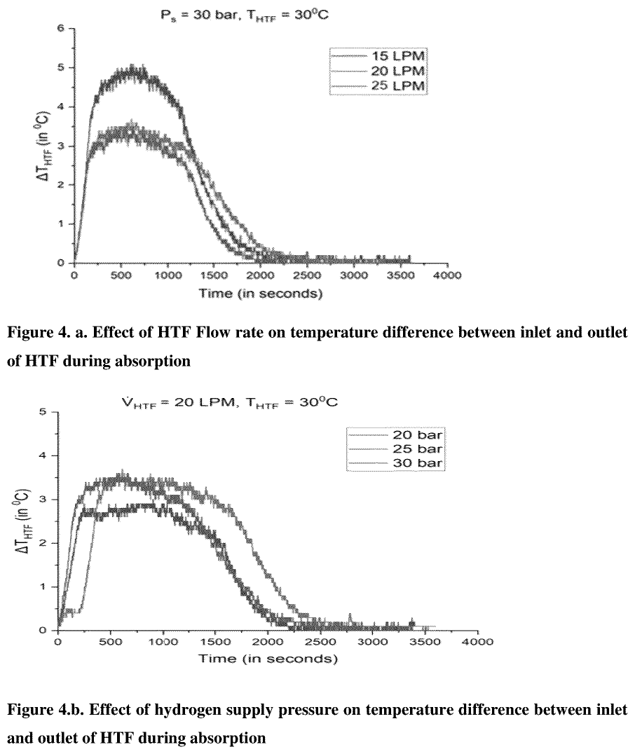

The absorption is an exothermic process wherein MH bed releases heat while absorbing hydrogen which is supposed to be dissipated in order to increase the rate of reaction. FIG. 4.a. depicts the temperature difference of water between shell inlet and outlet for different HTF flow rate for a time period of 3600 s which is also an indication of the rate of heat removal from MH bed and simultaneously the absorption rate. It was observed that for 15 LPM the ΔT water rises to 5° C. whereas it was reported to be 3.6° C. and 3.5° C. for 20 and 25 LPM respectively. This behavior is because of the longer contact time of HTF with the metal hydride reactor at lower flow rate.

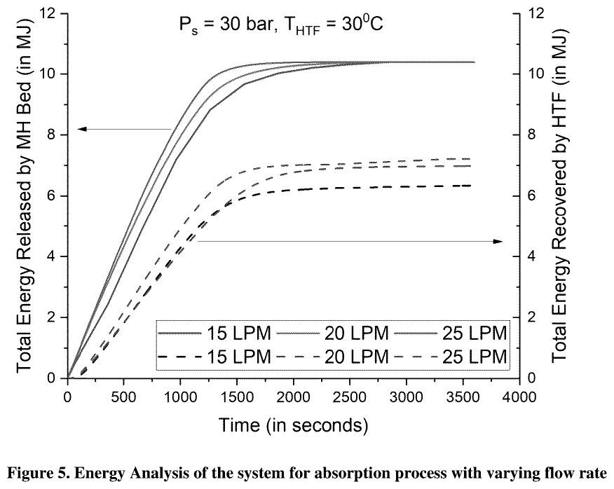

FIG. 5 shows the energy analysis for absorption process with different HTF flow rate for a period of 3600 s. It was observed that in order to store 680 grams of hydrogen in 50 kg LaNis, the total heat released during reaction was 10.39MJ. In terms of heat recovery from MH bed by varying HTF flow rate, the process was able to remove 6.34 MJ of energy at 15 LPM, 7 MJ at 20 LPM and 7.2 MJ of energy at flow rate of 25 LPM. The heat recovery by HTF fluid was 61%, 67.37% and 69.3% at a flow rate of 15 LPM, 20 LPM and 25 LPM respectively. The energy difference between the energy released by MH bed and energy recovered by HTF can be accounted as energy stored within the thermal mass of the reactor by means of conduction which is fabricated using SS316L and also heat transfer to the surrounding air by means of convection. The energy analysis helps in selection of HTF flow rate for further sets of experiments which was considered to be 20 LPM in case of absorption as stated in above graphs since the difference between total energy removed by HTF while increasing flow rate from 20 LPM to 25 LPM is 2%.

### Effect of Supply Pressure of H₂ Absorption in MH Bed:

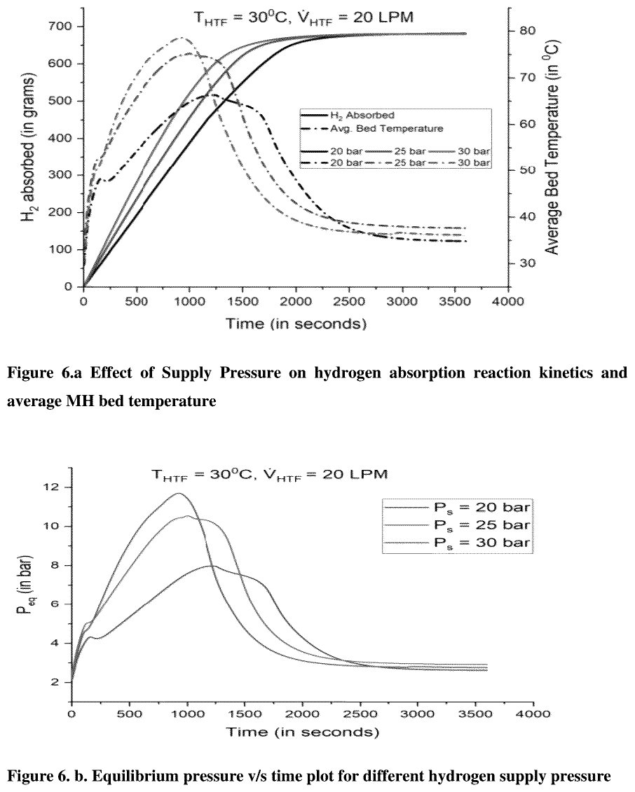

After analyzing the influence of HTF flow rate on hydrogen absorption, the next parameter considered for performance analysis of the reactor was hydrogen supply pressure to MH bed. In present invention, the H₂ supply pressure was increased from 20 bar to 30 bar in the steps of 5 bar keeping constant HTF flow rate of 20 LPM and HTF temperature at 30° C. The hydrogen absorption in MH bed is a function of the difference between supply pressure and equilibrium pressure of alloy. However, as the reaction proceeds further due to the exothermic nature of reaction the bed temperature increases and hence the equilibrium pressure also increases which is a function of MH bed temperature as evident from the van′t Hoff equation (equation 4). Initially during the absorption process the difference in supply pressure and equilibrium pressure dominates and further with increase in equilibrium pressure due to increment in bed temperature the reaction rate reduces wherein the impact of heat transfer comes into effect. At 20 bar, the 90% reaction fraction was achieved in 1741 s, and a maximum of 680.07 grams of hydrogen was absorbed in 3024 s with peak average bed temperature rise of 66.3° C. at 1206 s. In the case of 25 bar, the 90% reaction fraction completion time reduces to 1459 s and it took 2999 s to achieve maximum hydrogen storage capacity of 680.07 grams with peak average bed temperature rise to 75.2° C. at 1002 seconds. Further increment of supply pressure to 30 bar, it was observed that the rate of reaction was faster wherein it took only 1286 s for completion of 90% reaction fraction, and 2674 seconds for achieving maximum storage capacity with peak average bed temperature rise of 78.64° C. at 930 s as shown in FIG. 6.a. FIG. 6.b. shows the variation of equilibrium pressure of MH bed with respect to the variation in MH bed temperature computed using van′t Hoff equation. It was observed that initially (t=0) the pressure difference between supply pressure and equilibrium pressure are 17.84 bar, 22.84 bar and 27.84 bar at a hydrogen supply pressure of 20 bar, 25 bar and 30 bar respectively. This larger pressure difference initially acts as a major driving force for the reaction and as the reaction is exothermic, the bed temperature increases rapidly resulting in the increase of equilibrium pressure. Thus, driving force for the reaction tends to reduce until the HTF flowing across the shell at 30° C. starts extracting heat from MH bed which lowers the bed temperature (reduces equilibrium pressure) and hence results in enhancing the absorption kinetics. FIG. 4.b. shows the temperature difference between reactor's inlet and outlet of HTF which also indicates the rate of heat transfer from MH bed. It can be seen that when water with constant flow rate of 20 LPM was circulated across the shell of reactor, the ΔT_{water} variation for 20 bar is lesser as compared to 25 bar and 30 bar due to slower hydrogen sorption rate leading to prolonged time for complete absorption with water having sufficient residence time to cater the heat removal with lesser peak bed temperature. The peak ΔT_{water} variation was observed to be 2.9° C., 3.5° ° C. and 3.7° ° C. for 20 bar, 25 bar and 30 bar respectively.

In terms of comparison of the effect on reaction kinetics of three different supply pressure chosen for this study, it was found that for complete hydrogen sorption incremental increase in supply pressure from 25 bar to 30 bar leads to an improvement of 12.15% and from 20 bar to 30 bar, the reaction is faster by 13.15%. In terms of 90% reaction fraction completion, the reaction rate improved by 35.4% and 13.45% when supply pressure increased to 30 bar from 20 bar and 25 bar respectively. So as the improvement is more than 10% and reaction rate is faster with 90% reaction getting completed in 1286 s on incrementing the supply pressure from 25 to 30 bar, 30 bar was considered as a base case for further absorption experiments.

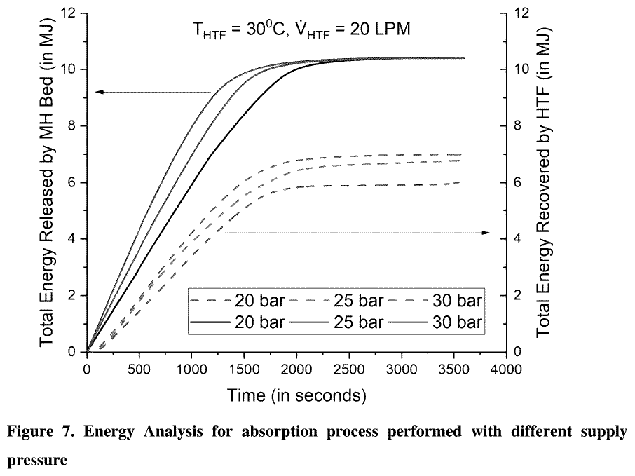

FIG. 7 shows the energy analysis for the absorption process performed at different supply pressures of 20 bar, 25 bar and 30 bar at a constant flow rate of 20 LPM for a duration of 3600 seconds. In this case, it was observed that the total energy released by MH was 10.39 MJ in order to store 680 grams of hydrogen. The increase in supply pressure increases the driving force for hydrogen absorption which in turn results in faster reaction rate and simultaneously faster heat generation from bed. This can also be correlated with the energy removed by HTF flowing through the shell at constant flow rate of 20 LPM wherein 7 MJ of heat was removed from the MH bed at supply pressure of 30 bar compared to 6.03 MJ and 6.78 MJ at a supply pressure of 20 bar and 25 bar respectively. Again the difference between energy released and energy recovered can be attributed to the energy stored in the thermal mass of the system and energy lost by means of convection to surrounding air.

Effect of HTF Flow Rate on H₂ Desorption from MH Bed:

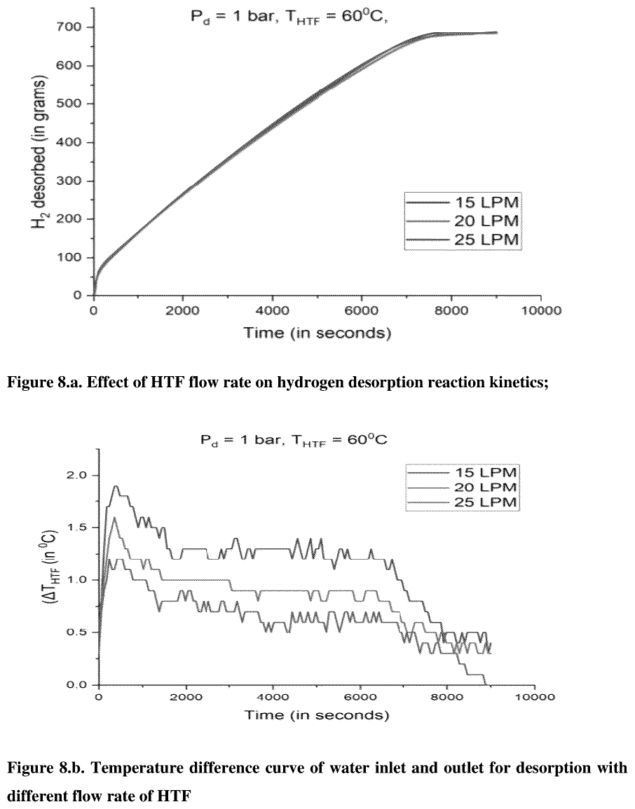

The hydrogen desorption from MH Bed is an endothermic process which requires energy to release hydrogen and the second criterion for the process is pressure difference between desorption equilibrium pressure of alloy bed at a particular temperature and the outlet pressure or surrounding pressure. In our case, the energy required for desorption was supplied by means of hot water as heat transfer fluid circulated using 0.5 HP water pump from water bath. Initially the impact of heat transfer fluid flow rate was analyzed on the rate of hydrogen desorption by varying water flow rate from 15 LPM to 25 LPM at temperature of 60° ° C. across the shell portion of the reactor and the hydrogen was desorbed at atmospheric pressure 1 bar. It was observed that 90% of the desorption reaction gets completed in 6171 s, 6165 s and 6133 s for HTF flow rate of 15 LPM, 20 LPM and 25 LPM respectively which is evident from FIG. 8.a. The average bed temperature drops maximum to 51° C. in 347 s for 15 LPM, in 255 s for 20 LPM and in 216 s for 25 LPM respectively, so overall a maximum temperature drop of 9.5° C. was observed in the initial phase of desorption within duration of 400 s where desorption rate was rapid due to larger pressure difference. FIG. 8.b. shows the variation in the temperature difference of the heat transfer fluid between inlet and outlet of reactor shell, wherein it was observed that for 15 LPM the ΔT_{water} is higher compared to the other flow rate of 20 LPM and 25 LPM due to the fact that the contact time or residence time between MH tubes and HTF resulting in higher temperature drop for a considered instant as compared to higher flow rates. In our study the peak ΔT_{water} value was observed to be 1.9° C., 1.6° C. and 1.2° ° C. at 15 LPM, 20 LPM and 25 LPM respectively. The heat transfer coefficient measured for desorption study using the Kern's method are 568.42 W/m²-K, 648.23 W/m²-K, and 736.94 W/m²-K for HTF flow rate of 15 LPM, 20 LPM and 25 LPM respectively. It can be observed that increasing heat transfer coefficient above 600 W/m²-K has no significant effect on hydrogen desorption from the MH bed. It was concluded from the results that the HTF flow rate has very least influence on hydrogen desorption rate and was observed to be less than 1% and therefore a flow rate of 15 LPM was considered for further desorption studies.

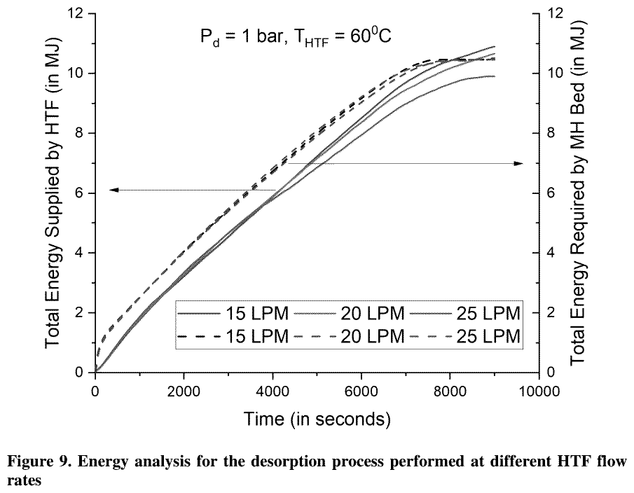

The energy analysis for the desorption process performed at 1 bar outlet pressure, constant HTF temperature of 60° C. and different HTF flow rates of 15, 20 and 25 LPM is shown in FIG. 9. It can be seen that the rate of energy required by MH bed is same at any instant of time even after varying flow rates. The total energy required by the MH bed to desorb stored hydrogen is 10.4 MJ. It was observed that in case of desorption the total energy supplied by lower flow rate of 15 LPM was maximum which was 10.89 MJ wherein it was 10.65 MJ for 20 LPM and 9.9 MJ for 25 LPM. The higher energy supply at lower flow rates with constant temperature of HTF is due to the larger residence time accompanied between fluid particles and MH tubes along with higher temperature difference as observed in FIG. 8.b. Further, the most important outcome from this energy analysis observed was that the energy required by MH Bed was higher than the energy supplied by HTF at 60° ° C., so the difference between the required and supplied heat during desorption process due to faster rate of desorption is compensated by MH bed itself by extracting the sensible energy stored within MH by lowering its temperature. Further continuous heat transfer from HTF fluid to the MH bed meets the energy requirement for completion of the desorption process by maintaining bed temperature.

Effect of HTF Temperature on Hydrogen Desorption from MH Bed

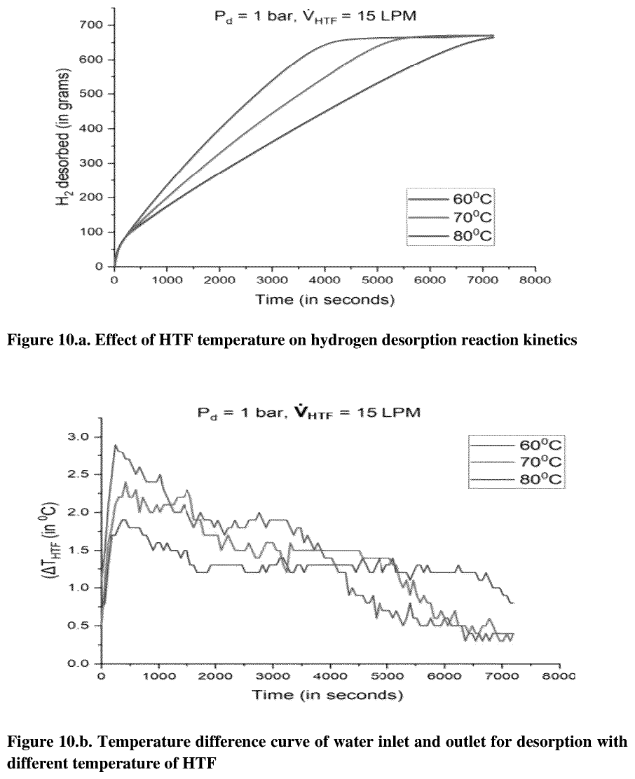

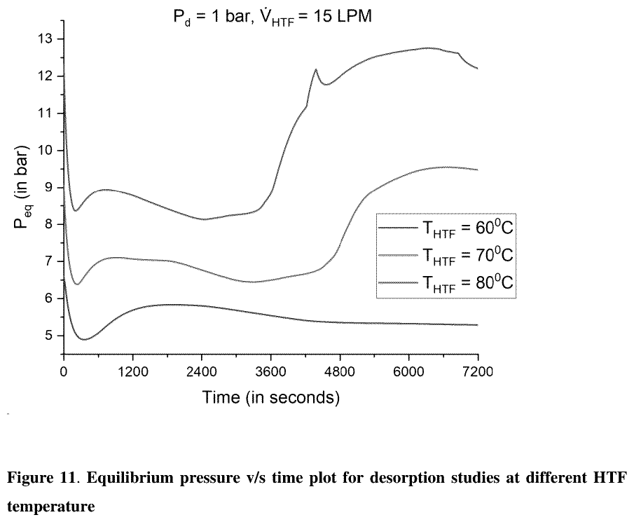

After analyzing the effect of HTF flow rate, the effect of HTF temperature or MH bed temperature was analyzed by varying the HTF temperature from 60° C. to 80° C. keeping the constant flow rate of 15 LPM and desorbing hydrogen to atmospheric pressure. The driving force for the desorption process is dependent on the pressure difference between equilibrium pressure at a particular MH bed temperature and outlet pressure. The increment of HTF temperature raises the bed temperature which in turn raises the equilibrium pressure of alloy and thereby the desorption rate kinetics. FIG. 10.a. indicates the effect of HTF temperature on hydrogen desorption rate for duration of 7200 s, it was observed that for desorbing 90% of the hydrogen from MH bed it took 6172 s when fluid was circulated at 60° ° C. whereas it takes 4654 s and 3616 s only for HTF circulated at temperature of 70° C. and 80° C. respectively. In terms of the temperature drop of MH bed during desorption, it was observed that for HTF at 60° C. the maximum temperature drop was 51.75° C. at 347 s, similarly for HTF at 70° C. it was observed to be 59.49° C. at 227 s and for HTF at 80° ° C. the temperature drop was significant compared to other cases above reported to 67.76° C. at 209 s which is almost a 13° C. drop signifying the higher rate of desorption at this particular temperature. In terms of HTF temperature difference between water inlet and outlet of reactor signifying the rate of heat supply to MH bed for desorption of hydrogen as per FIG. 10.b., it was observed that peak temperature drop was 1.9° C., 2.4° C. and 2.9° ° C. for HTF at 60° ° C., 70° C. and 80° ° C. respectively. FIG. 11 shows the effect of HTF temperature on the desorption equilibrium pressure. The equilibrium pressure for LaNis calculated using van't hoff equation are 6.59 bar, 9.06 bar and 12.30 bar at initial MH bed temperature of 60° C., 70° ° C. and 80° C. respectively. Due to the larger pressure difference initially, the rate of desorption used to be faster. The reaction being endothermic in nature, there is higher energy requirement initially which MH bed utilizes from its own stored energy apart from the energy supplied by HTF which can be correlated with the drop in the MH bed temperature. Further, circulation of HTF at constant temperature leads to sufficient energy supply for complete desorption. In terms of overall analysis of the effect of temperature it was found that increasing the HTF temperature from 60° ° C. to 80° C. results in 41.4% reduction in the desorption time, whereas for increment from 70° ° C. to 80° ° C. the desorption time reduces by 22.3% resulting in higher rate of hydrogen desorption from MH bed.

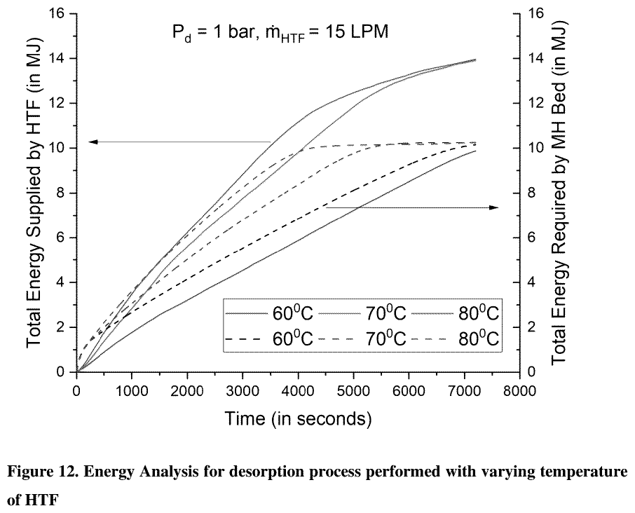

FIG. 12 shows the energy analysis computed for the desorption process performed at atmospheric pressure with a constant HTF flow rate of 15 LPM and at different HTF temperatures of 60° C., 70° C. and 80° ° C. In the desorption process, increasing the MH bed temperature increases the desorption equilibrium pressure which in turn increases the driving force for hydrogen desorption resulting in higher rate of hydrogen desorption accompanied by higher instantaneous energy requirement. In the present study, it was observed that for a period of 7200 seconds, the energy supplied by HTF at 60° C. was 9.87 MJ, at 70° ° C. it was 13.89 MJ and at 80° ° C. it was 13.95 MJ. It was clearly evident that the desorption is slower for HTF at 60° C. and there exist difference between energy required by MH bed and energy supplied by HTF for entire experimental duration due to which it takes more than 7200 s for MH for complete desorption at 60° C. compared to desorption at other HTF temperatures. The results also depict that increasing HTF temperature reduces the energy gap significantly and enhances the desorption rate to a greater extent. In terms of energy supply by different temperatures of HTF, we compared the energy supplied by HTF at 1800th second, and the values obtained were 2.9 MJ, 4.93 MJ and 5.72 MJ for 60° C., 70° C. and 80° C. respectively.

In the present invention, the experimental studies on the performance analysis of the multi tubular metal hydride reactor with integrated buffer storage design was analyzed by varying the different operating parameters with different levels in for both absorption and desorption processes. The results obtained are as follows:

1. In case of absorption, the effect of HTF flow rate studied by varying it from 15 LPM to 25 LPM wherein it was observed that for completion of 90% absorption reaction, the absorption time reduces from 1451 s for 15 LPM to 1286 s for 20 LPM and 1154 seconds for 25 LPM. The flowrate of 20 LPM was selected as an optimum flow rate for further experiment as energy supplied by HTF at 20 and 25 LPM and also the absorption time did not have a significant difference. The LaNis bed stores a maximum of 680 grams of hydrogen which is equivalent to 1.34 wt. % of gravimetric capacity.

2. The effect of supply pressure was analyzed by varying the hydrogen supply pressure from 20 bar to 30 bar in steps of 5 bar wherein it was observed that for achieving maximum hydrogen storage capacity of 1.34 wt. % it took 3024 s, 2999 s, and 2674 s for supply pressure of 20 bar, 25 bar and 30 bar respectively. The absorption rate was faster for 30 bar supply pressure which took only 1286 s for of hydrogen absorption compared to 1459 s and 1741 s for 25 bar and 20 bar for 90% reaction completion.

3. The desorption studies were conducted by varying HTF flow rate from 15 LPM to 25 LPM keeping bed temperature constant at 60° ° C. It was found that the HTF fluid flow rate has very least significant effect on hydrogen desorption from MH bed which was less than 1% with constant MH bed temperature drop of 9.5° C. and hence flow rate of 15 LPM was considered for further studies.

4. It was found that increasing heat transfer coefficient beyond 600 W/m²-K does not have significant effect on heat transfer from the MH bed during charging and discharging of hydrogen.

5. Further, heat transfer fluid temperature is increased from 60° ° C. to 80° C. with HTF flow rate of 15 LPM and desorbing hydrogen at atmospheric pressure. The increment in HTF fluid temperature had a very prominent effect on hydrogen desorption rate. It was observed that 90% of the hydrogen desorbs only in 3616 s when HTF temperature was kept 80° C. compared to 4654 s and 6172 s for HTF temperature of 70° C. and 60° C. respectively. The increase in heat transfer fluid temperature resulted in saving 41.4% of desorption time when it was incremented from 60 to 80° ° C. In the overall context of desorption experiments, it can be concluded that among the analyzed parameters HTF temperature or specifically MH bed temperature is vital in enhancing the rate of hydrogen desorption.

We claim:

1. A multi tubular metal hydride reactor with integrated buffer storage arrangement comprising:
i. Shell housing for heat transfer fluid (HTF) wherein water acts as a cooling/heating HTF;
ii. 7 metal hydride (MH) tubes filled with LaNis metal hydride powder within the shell wherein each MH tube has embedded heat transfer unit (fin assembly) in MH powder for heat transferring from and to the central core;
iii. 4 longitudinal fins inserted in each MH tubes which are fixed to 5 central rings to enhance the heat transfer and for uniform metal hydride filling throughout the tubes; The thickness of each fin plate; diameter, thickness and length of central rings is optimized and based on the mechanical strength consideration, uniform distribution of MH powder and heat transfer area required. For any higher capacity, the number of fins, its thickness, diameter and length and number of central rings would vary as per capacity;
iv. 4 baffle plates for supporting the MH tube which also provide additional heat transfer surface area and create turbulence for heat transfer;
v. Hydrogen gas (H₂) inlet into the integrated buffer and acting on the circular area providing sufficient area for hydrogen inlet while minimizing the pressure loss;
vi. Two end plates to separate the HTF and gas circuits;
vii. MH tubes protrude the top and bottom plate;
viii. Disc filter to separate the gas and MH powder during the desorption operation as well as to supply hydrogen to the MH tubes;
ix. Two hemispherical covers to close the top and bottom portions of the reactor;
x. The volume enclosed within top hemispherical cover and top end plate act as integrated buffer hydrogen storage;
xi. Inlet and outlet for HTF across the shell to allow the flow of the HTF inside the shell area of the reactor.

2. The multi tubular metal hydride reactor with integrated buffer storage arrangement as claimed in claim 1 wherein during absorption of hydrogen HTF flow rate is in the range from 15 LPM to 25 LPM and Hydrogen supply pressure is in the range from 20 bar to 30 bar.

3. The multi tubular metal hydride reactor with integrated buffer storage arrangement as claimed in claim 1 wherein during desorption of hydrogen HTF flow rate is in the range from 15 LPM to 25 LPM and HTF temperature is in the range from 60° C. to 80° C.

4. A method for carrying out the process of absorption and desorption of hydrogen in metal hydride in multi tubular metal hydride reactor with integrated buffer storage arrangement characterized in that:
i. During absorption process the HTF flow rate is in the range from 15 LPM to 25 LPM and Hydrogen supply pressure is in the range from 20 bar to 30 bar; and
ii. During desorption process HTF flow rate is in the range from 15 LPM to 25 LPM and HTF temperature is in the range from 60° C. to 80° C.

5. The method for carrying out the process of absorption of hydrogen in metal hydride in multi tubular metal hydride reactor as claimed in claim 4 wherein absorption take place at HTF flow rate of 20 LPM and Hydrogen supply pressure of 30 bar.

6. A method for carrying out the process of desorption of hydrogen from metal hydride in multi tubular metal hydride reactor as claimed in claim 4 wherein desorption take place at HTF flow rate of 15 LPM and HTF temperature of 80° C.
